(19) United States
(12) Patent Application Publication
(10) Pub. No.: US 2006/0059742 A1
(43) Pub. Date: Mar. 23, 2006

(54) LED sign with continuous illumination effect

(76) Inventor: Frank Pan, Rosemead, CA (US)

Correspondence Address: RAYMOND Y. CHAN, 108 N. YNEZ AVE., SUITE 128, MONTEREY PARK, CA, 91754, US

(21) Appl. No.: 10/982,741

(22) Filed: Nov. 5, 2004

Related U.S. Application Data
(63) Continuation-in-part of application No. 10/884,583, filed on Jul. 2, 2004.

(51) Int. Cl. G09F 13/22

(52) U.S. Cl. 40/544

(57) ABSTRACT

A LED sign includes at least a light guider, which is shaped as a sign word, defining an illumination channel therealong and a plurality of LED illuminators spacedly disposed underneath the light guider at a light diffusion distance for generating lights towards the illumination channel in such a manner that the lights are accumulated within the illumination channel to highlight the light guider so as to form a continuous illumination effect as a neon light effect.

### CROSS REFERENCE OF RELATED APPLICATION

This is a Continuation-In-Part application of a non-provisional application having an application Ser. No. 10/884,583 and filing date of Feb. 19, 2004.

### BACKGROUND OF THE PRESENT INVENTION

1. Field of Invention

The present invention relates to a LED (Light Emitting Diode) sign, and more particularly to a LED sign with continuous illumination effect which is capable of forming a line of light source from a plurality of LED illuminators for highlighting particular characters, such as an advertisement sign.

2. Description of Related Arts

Illuminating devices are widely utilized to perform differing commercial or business tasks. For example, advertisements are highlighted by light boxes so that during night time people can be notified and attracted by sharp and colorful advertisements. Besides, neon signs are usually set up in front of shops showing the opening status of them.

There exist a handful of illuminating devices in the marketplace, the two most popular being neon lights and advertisement light boxes in that they are conveniently available in regular business equipment suppliers and that they can sustain prolonged usage without getting out of order frequently. However, these cannot be taken to mean that they are free from disadvantages. In fact, some people are actually forced to tolerate those disadvantages and continue using them simply because they cannot find suitable alternatives.

A major disadvantage of conventional light boxes and neon lights is that they generate a large amount of heat while operating. Not to mention safety problem resulting from such heat, this large amount of heat itself represents a serious waste of large amount of energy which in turns reflects in unnecessary yet inevitable rise of the user's operating cost. Thus it comes to a lose-lose situation that the user pays higher for more serious loss of natural resources (electricity) without gaining any extra economic profit.

Another disadvantage is that conventional neon light or fluorescent light box is extremely fragile to physical impact. Thus, one has to put extra care in transporting the neon lights or the light boxes in order to prevent accidental damage on the part of them. This not only increases the cost of handling such products, but also presents a potential risk to those handling or purchasing the products.

As a matter of fact, engineers are eager to seek alternatives for those conventional neon lights and advertisement light boxes. For example, they have thought of using LEDs for generating light to replace conventional neon lights and fluorescent lamps. However, there exist some inherent disadvantages for using LEDs. For example, despite the fact that LED is more long-lasting and economically more efficient, light from each particular LED is not generally strong enough for highlighting an advertisement or business signs. As a result, there exist some LED light boxes which comprise a plurality of LEDs electrically connected with each other to generate sufficient amount of illumination as a whole. However, as each LED represents a single point source of light, each light box eventually comes up with a plurality of discrete light sources and the overall illumination effect is far from satisfactory. Thus, the problem of how to convert what is originally discrete single points of light source to a continuous line of light source is a pressing problem for engineers.

### SUMMARY OF THE PRESENT INVENTION

A main object of the present invention is to provide a LED sign which is capable of forming a uniform line of light source from a plurality of LED illuminators for highlighting a particular character, such as an advertisement sign.

Another object of the present invention is to provide a LED sign comprising at least one light guider for forming an illumination channel which accumulates light from a plurality of LED illuminators to form a continuous illumination effect for highlighting a predetermined character, such as a particular advertisement sign.

Another object of the present invention is to provide a LED sign comprising at least a character sign of a predetermined color and aesthetic pattern so that it may either be highlighted by the LED illuminators to form the continuous illumination effect, or, where the LED illuminators are not lit up, arranged to display a particular character by virtue of its own color and aesthetic pattern without the lighting from the LED illuminators. In other words, the particular character sign, such as the advertisement, may be used anytime with or without the LED illuminators lighting.

Another object of the present invention is to provide a LED sign which is simple in structure yet capable of delivering a continuous illumination light effect. In other words, the manufacturing cost and the ultimate selling price of the present invention must be minimized.

Another object of the present invention is to provide a LED sign which is durable, effective, efficient, and economical during operation.

Accordingly, in order to accomplish the above objects, the present invention provides a LED sign, comprising:
a figure sign shaped to form at least a character;
at least a light guider, which is shaped corresponding to the figure sign, having a plurality of light cavities and an illumination channel communicating with the light cavities, wherein the figure sign is supported by the light guider to optically communicate with the illumination channel; and
a plurality of LED illuminators spacedly disposed within the light cavity of the light guider for generating lights towards the illumination channel in such a manner that the lights are accumulated within the illumination channel to form a continuous illumination effect so as to project towards and to highlight the figure sign.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of a LED sign according to a preferred embodiment of the present invention.

FIG. 1B illustrates an alternative mode of the LED sign according to the above preferred embodiment of the present invention.

FIG. 2A is a schematic sectional side view of the LED sign according to the above preferred embodiment of the present invention.

FIGS. 2B and 2C illustrate another alternative mode of the LED sign according to the above preferred embodiment of the present invention.

FIG. 2D is a schematic top view of the LED sign according to the above preferred embodiment of the present invention.

FIGS. 3A and 3B illustrate the first alternative mode of the LED sign according to the above preferred embodiment of the present invention.

FIG. 3C is a schematic top view of the alternative mode of the LED sign according to the above preferred embodiment of the present invention

FIG. 4 is a second alternative mode of the LED sign according to the above preferred embodiment of the present invention.

FIGS. 5A and 5B illustrate third alternative mode of the LED sign according to the above preferred embodiment of the present invention.

FIG. 6 is a perspective view of a LED sign according a second preferred embodiment of the present invention.

FIG. 7 is a sectional view of the LED sign according to the above second preferred embodiment of the present invention.

FIG. 8 illustrates an alternative mode of the LED sign according to the above second preferred embodiment of the present invention.

### DETAILED DESCRIPTION OF THE PREFERRED EMBODIMENT

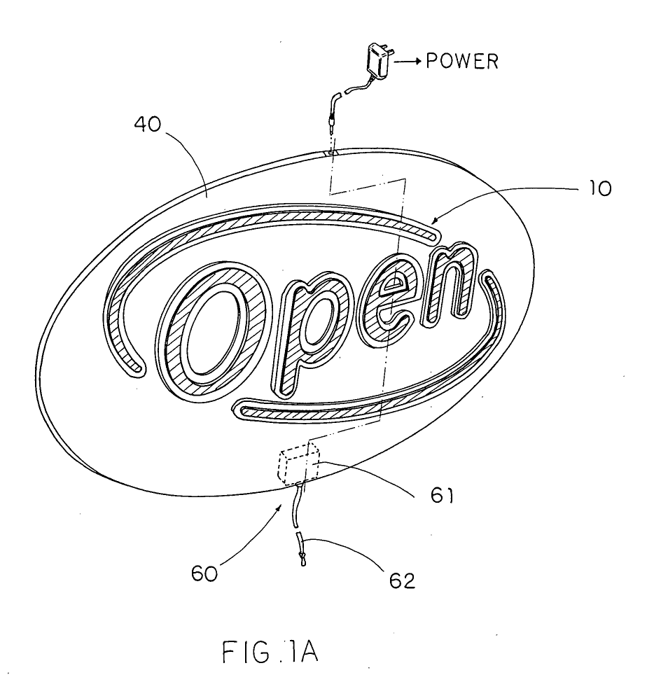

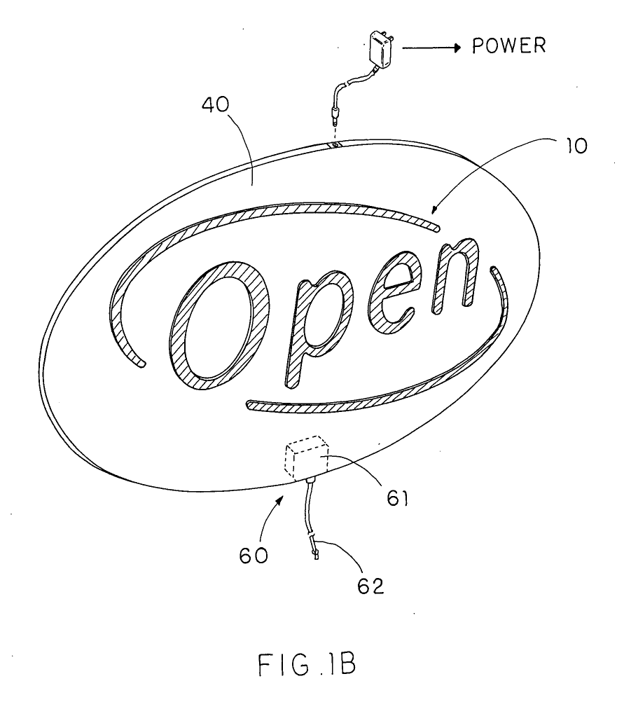

Referring to FIG. 1A of the drawings, a LED sign according to a preferred embodiment of the present invention is illustrated, in which the LED sign comprises a figure sign 10, at least one light guider 20, and a plurality of LED illuminators 30.

The figure sign 10 is shaped as forming a particular character having a predetermined light transmisivity and color. For example, the figure sign 10 may be embodied as a ‘O’ character in which it may be coated with a particular color for particular purpose, such as for use in a particular advertisement campaign. In addition, the figure sign 10 can be shaped as a line, character, number, or even an aesthetic figure to incorporate with the light guider 20.

The light guider 20 is shaped corresponding to the figure sign 10, wherein it is overlappedly supported on a central portion of a front side of the light guider 20 and optically communicated with the illumination channel 21. Moreover, the light guider 20 further has a plurality of light cavities 23 for receiving the LED illuminators 30.

The plurality of LED illuminators 30 are spacedly disposed within the light cavity 23 of the light guider 20 for generating lights towards the illumination channel 21 in such a manner that the lights so generated are accumulated within the illumination channel 21 so as to form a continuous illumination effect, such as a neon light effect, and projected towards the figure sign 10 for highlighting that particular character, such as the character ‘S’.

The light guider 20 comprises an elongated solid member made of translucent materials to form the illumination channel 21 in a solid manner such that when the LED illuminators 30 project the light towards the illumination channel 21, the light are evenly diffused along the illumination channel 21 to form the continuous illumination effect.

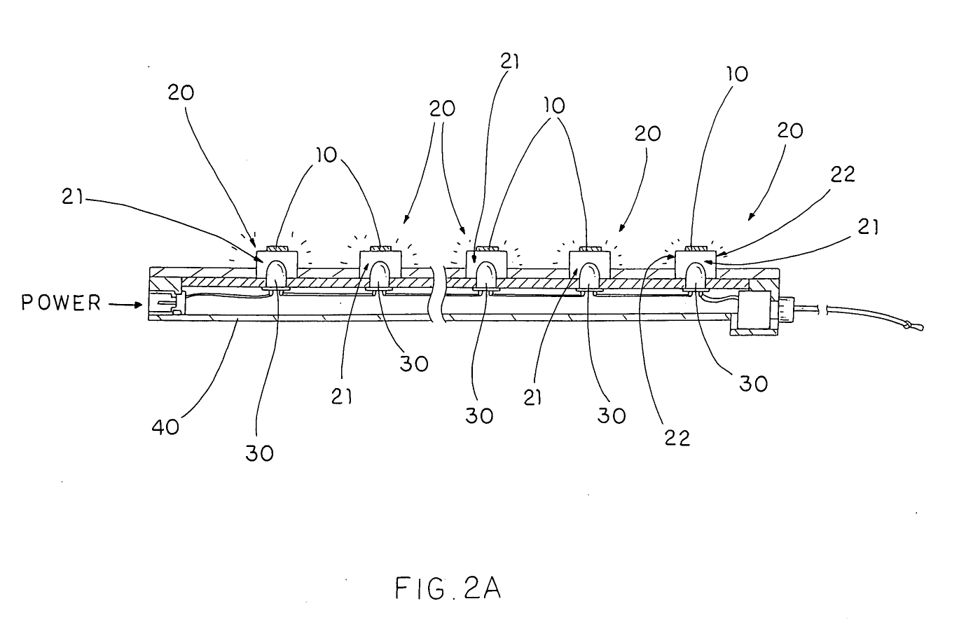

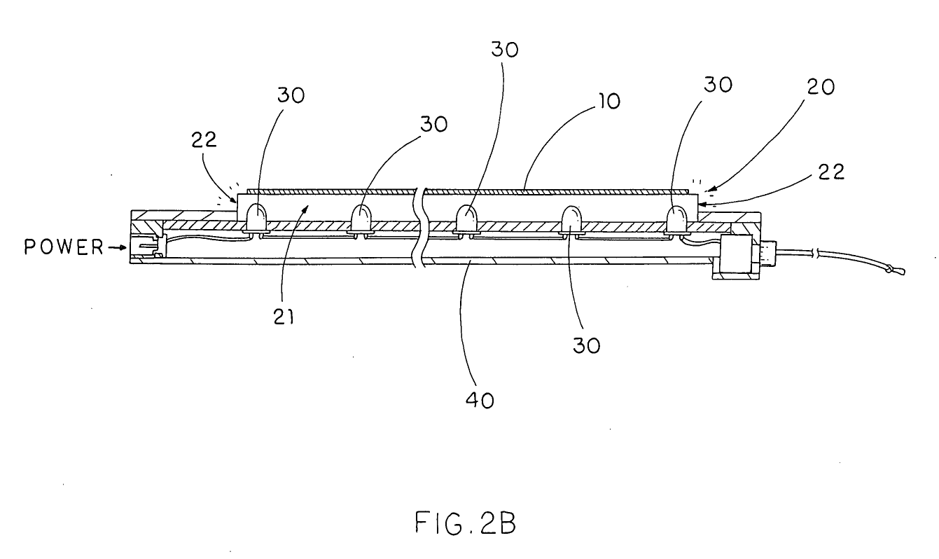

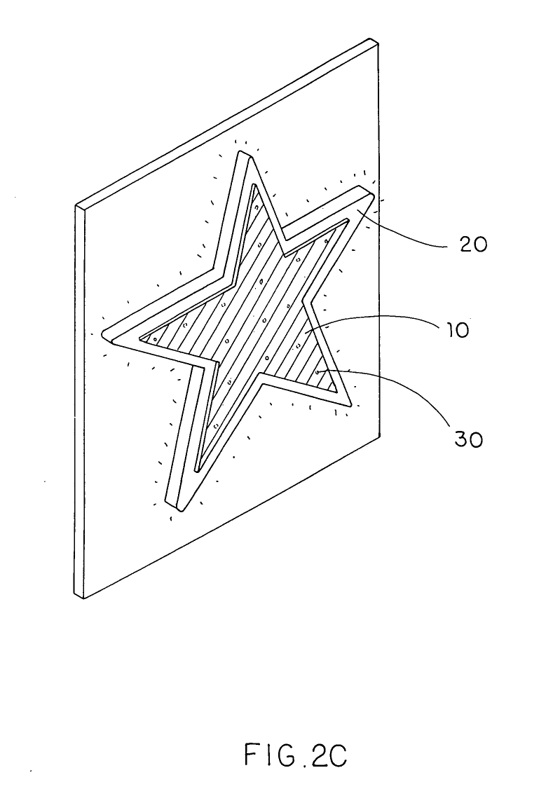

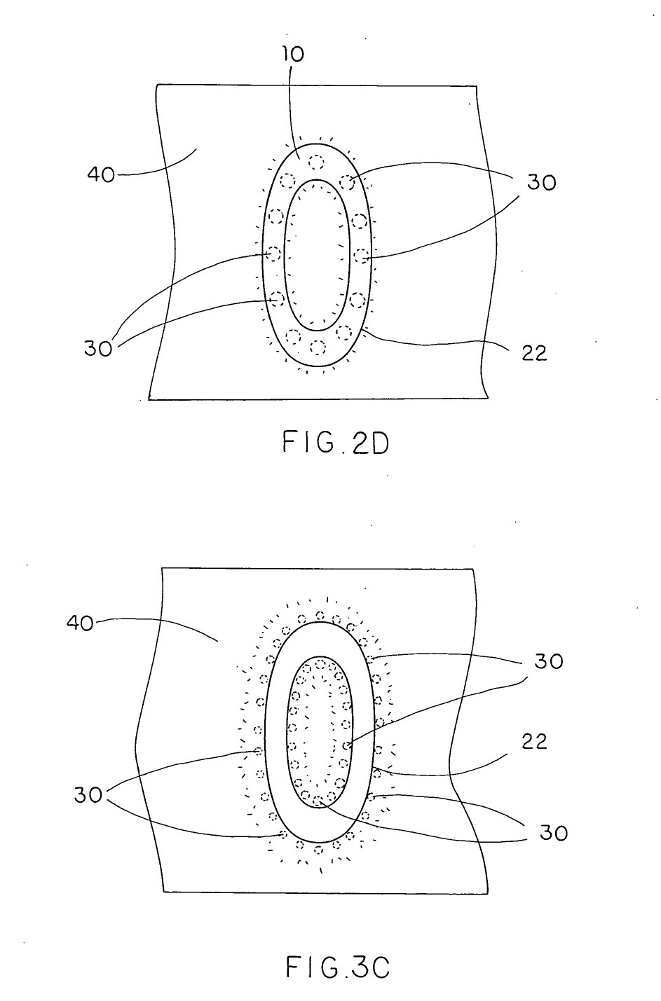

Therefore, the illumination channel 21 is a physical passageway which has a predetermined light transmisivity so as to allow light passing therethrough. Referring to FIG. 2 of the drawings, the illumination cavities 23 are indently formed along a rear side of the light guider 20 to receive the LED illuminators 30 respectively, in such a manner that a head portion of each of the LED illuminators 30 is embedded on the rear side of the light guider 20 towards the figure sign 10.

Each of the LED illuminators 30 is adapted to radiate light at an angle of approximately 120° frontwardly from a head portion of that LED illuminator 30. According to the preferred embodiment, the head portion is arranged to directly face the illumination channel 21 such that a maximum intensity of light is propagated to the illumination channel 21 for forming the single line of light source to highlight the figure sign 10.

Accordingly, the LED illuminators 30 are aligned along the illumination channel 21 at a center portion thereof such that when the LED illuminators 30 generate the light, a plurality of black spots may formed along the light guider 20. Therefore, the figure sign 10 is used to mount on the center portion of the light guider 20 to cover the black spots of the LED illuminators 30 during operation, as shown in FIG. 2D. In other words, the figure sign 10 is used to not only screen the black spots formed by the LED illuminators 30 but also enhance the visibility of the light guider 20 when the figure sign 10 is highlighted.

It is worth to mention that the figure sign 10 can be omitted when the light guider 20 is made of translucent material having a light transmisivity adapted to cover the black spots of the LED illuminators 30 such that when the LED illuminators 30 generate the light within the illumination channel 21 to penetrate through the light guider 20 so as to form the continuous effect when the black spots are invisibly blocked by the light guider 20.

The LED sign further comprises a supporting frame 40 having a displaying side that the light guider 20 is protruded therefrom to substantially support the light guider 20 in position, wherein the LED illuminators 30 are spacedly supported on the supporting frame 40 along the illumination channel 23 of the light guider 20.

Each of the LED illuminators 30 are electrically connected with each other in the supporting frame 40 which is then electrically connected to a power source for lighting up the LED illuminators 30 through a power inlet provided on the supporting frame 40.

The supporting frame 40 may be longitudinally extended to form an elongated structure wherein a plurality of light guiders 20 and figure signs 10 are protruded therefrom so as to form a large-scale advertising sign. For example, the advertising sign may be ‘OPEN’ or the likes, as shown in FIG. 1 of the drawings.

Thus, the LED sign further comprises a control switch 60 provided on the supporting frame and electrically connected with the LED illuminators 30 for controlling an operation of the LED illuminators 30. According to the preferred embodiment, the control switch 60 comprises a control box 61 mounted on a bottom portion of the supporting frame 40, and an actuation string 62 operatively extended from the control box 61 in such a manner that it is capable of being pulled to alternatively turn on an off the LED illuminators 30. In other words, a user is able selectively turn on or off the LED sign by slightly pulling the actuation sting 62.

From the foregoing descriptions, it can be shown that when the LED illuminators 30 are connected to a power source, such as the external AC power source or a DC power source, they would be lit up and generate light in the illumination cavity 23 towards the illumination channel 21. The light in the illumination channel 21 would then accumulate and form a line of light source projecting towards the figure sign 10. The light would then pass through the illumination channel 21 to reach an outside of the light guider 20 through a front side edge portion thereof in such a manner as to highlight the figure sign 10. The figure sign 10 may also be made to be light transmissible but having a light transmisivity different from that of the illumination channel 21, in such a case, difference in the transmisivity would produce special light effect to the LED sign of the present invention. Ultimately, it is worth mentioning that the discrete LED illuminators 30 are arranged to generate a single line of light source for highlighting the figure sign 10.

Accordingly, the figure sign 10 can be made of opaque material, and shaped and sized corresponding to the light guider 20, as shown in FIG. 1B, wherein when the LED illuminators are switched off, the figure sign 10 physically forms a display sign in a solid font manner, and when the LED illuminators 30 are switched on, the light within the illumination channel 21 forms the continuous illumination effect to encircle a surrounding edge of the figure sign 10 in a shaded font manner. In other words, the figure sign 10 is embodied as a sign that allows to be seen at the daytime when the LED illuminators 30 are switched off wherein the figure sign 10 is highlighted to encircle the surrounding edge thereof at the nighttime when the LED illuminators 30 are switched on. Thus, the opaque FIG. 10 can substantially cover the black spots of the LED illuminators 30.

Alternatively, the figure sign 10 can be made of translucent material having a light transmisivity adapted to cover the black spots of the LED illuminators 30 so as to invisibly block the black spots of the LED illuminators 30. As shown in FIGS. 2B and 2C, the light guider 20 is shaped to have an aesthetic pattern wherein the figure sign 10 covers on the light guider 20 such that when the LED illuminators 30 generate the light, the surrounding edge of the figure sign 10 is highlighted.

In addition, the figure sign 10 can be colored, such as red, blue, or yellow, such that the figure sign 10 not only covers the black spots of the LED illuminators 30 but also generates multi-colored illumination effect as the neon light effect when the figure sign 10 is highlighted.

Furthermore, the figure sign 10 can be furnished with a particular pattern of light effect or aesthetical design such that even when the LED illuminators 30 are not in use, the figure sign 10 by itself would also present a complete visible sign, though without illumination.

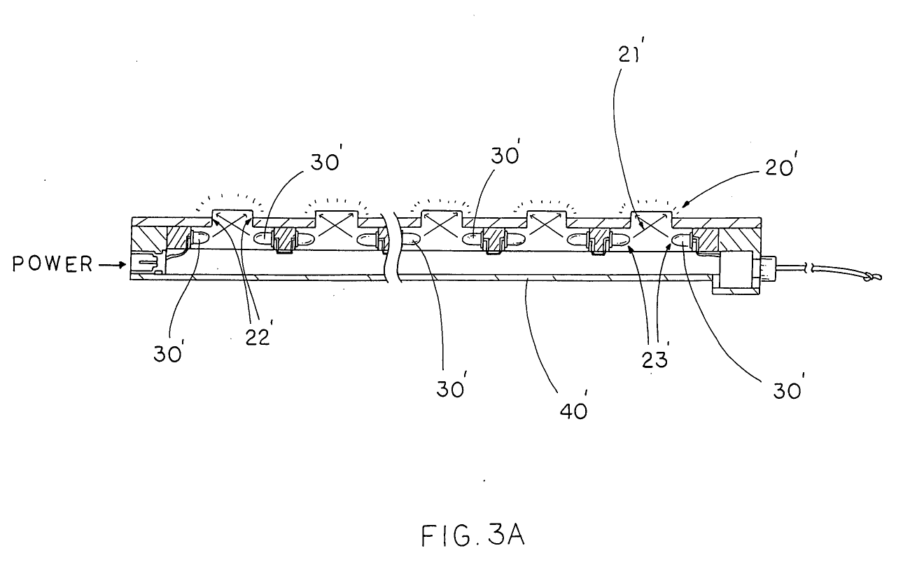

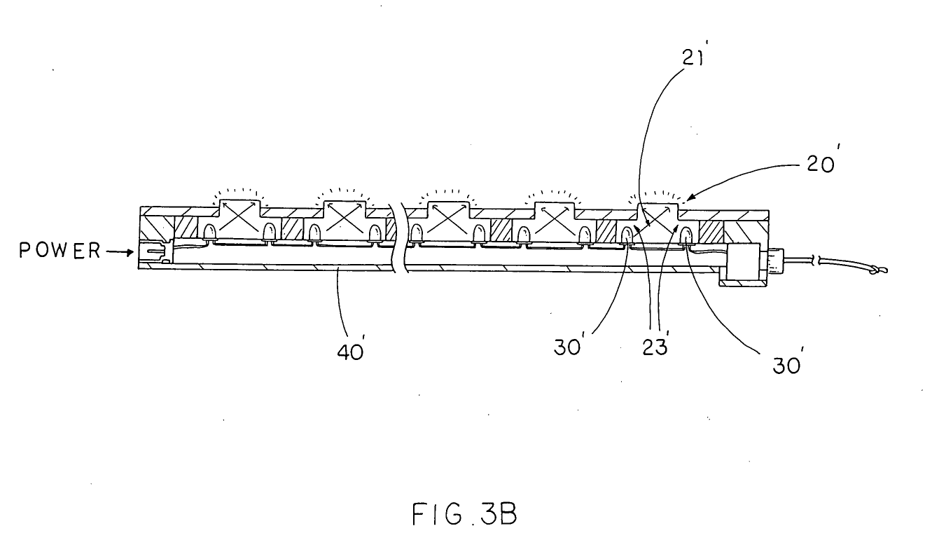

Referring to FIG. 3A of the drawings, an alternative mode of the LED sign according to the preferred embodiment of the present invention is illustrated. According to the alternative mode, the light guider 20′ has two sidewalls 22′ forming two illumination cavities 23′ along two sides of the illumination channel 21′ respectively wherein the LED illuminators 30′ are spacedly disposed in the illumination cavities 23′ for generating light towards the illumination channel 21′. The light from the LED illuminators 30′ are internally reflected and accumulated within the illumination channel 21′ to form a continuous light effect projecting towards the light guider 20′ in a continuous illuminating manner.

In order to enhance the light accumulation performance, the light guider 20′ further comprises two light reflecting layers provided on a rear wall of the illumination channel 21′ for intensifying internal light reflections therewithin. The light reflecting 30 layer is preferably embodied as a silver layer coated on the rear wall of the light cavities 23′ respectively, wherein light from the LED illuminators 30′ would impinge upon the light reflecting layer and results in intense multiple reflections within the illumination channel 21′ to form the line of light source. Obviously, other kind of light reflectors layers, such as mirrors, which can also cause this reflection pattern within the illumination channel 21′, may be utilized as alternatives.

It is worth to mention that since the LED illuminators 30′ are disposed along two sides of the light guider 20′, as shown in FIG. 3C, no black spot is formed along the illumination channel 21′ such that the figure sign 10 can be omitted. In other words, when the LED illuminators 30′ generate the light towards the illumination channel 21′ to form the single line illuminating effect as the neon light effect, the black spots formed by the LED illuminators 30′ are hidden within illumination cavities 23′ along two sides of the illumination channel 21′ respectively such that the black spots of the LED illuminators 30′ are invisible along the illumination channel 21′.

As a slight alternative of the first alternative mode, as shown in FIG. 3B of the drawings, the respective head portion of each of the LED illuminators 30′ may be mounted to face towards the front in the respective illumination cavity 23′, i.e. towards the figure sign 10′.

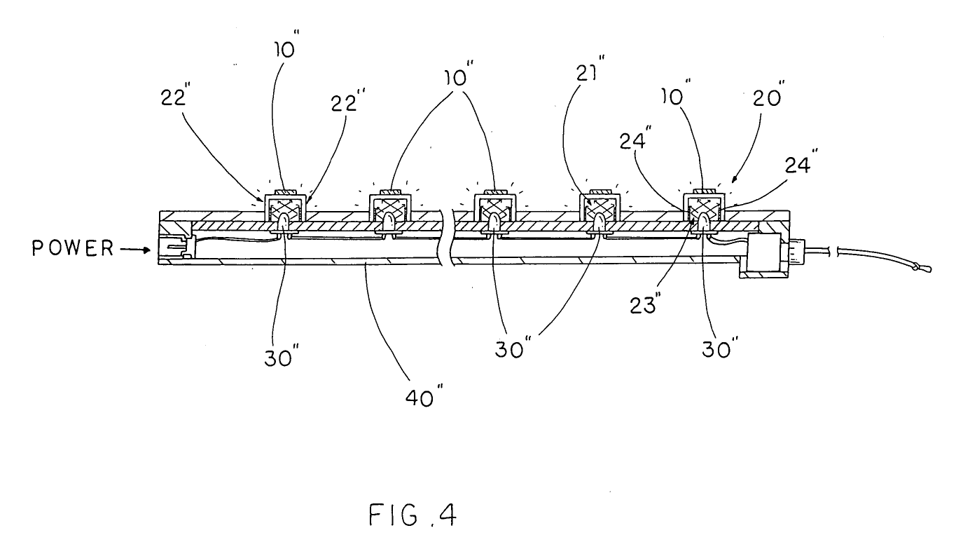

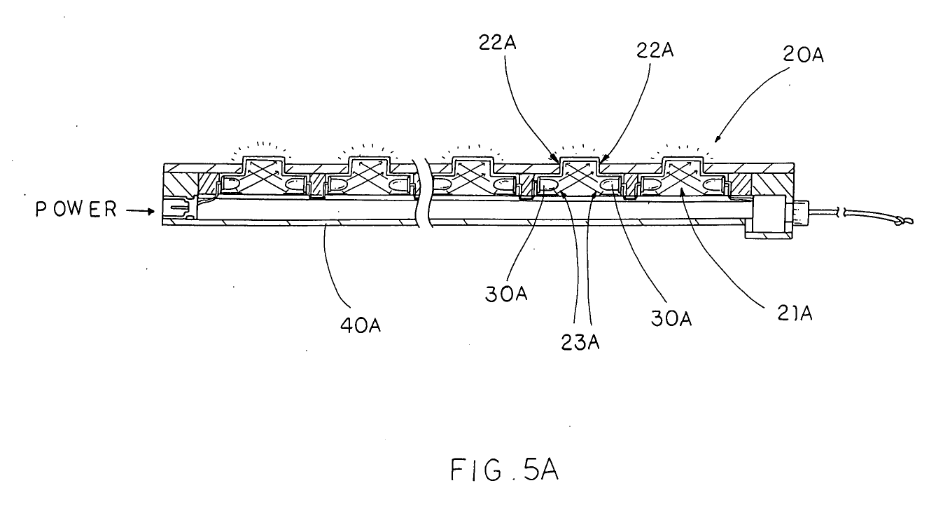

FIG. 4 illustrates a second alternative mode of the LED sign according to the above preferred embodiment of the present invention, in which case the light guider 20″ comprises an elongated hollow member made of translucent material to define the illumination channel 21″ therewithin and the light cavities 23″ along the illumination channel 21″, such that when the LED illuminators 30″ project the lights towards the illumination channel 21″, the light are evenly diffused along the illumination channel 21″ to form the continuous illumination effect as the neon light effect.

In order to further enhance internal reflections inside the illumination channel 21″, the light guider 20″ further comprises two side reflectors 24″ provided on two sidewalls 22″ thereof in the light cavities 23″ respectively so as to substantially reflect those portions of light impinging on the sidewall 22″ back to the illumination channel 21″. As such, the line of light source forming in the illumination channel 21″ will be of improved coherence.

The two side reflectors 24′ are preferably embodied as two reflective mirrors or silver coatings from which the light can be substantially reflected back to the illumination channel 21′.

It is worth to mention that the LED illuminators 30″ are aligned along the illumination channel 21″ at a center portion thereof such that when the LED illuminators 30″ generate the light, a plurality of black spots may formed along the light guider 20″. Therefore, the figure sign 10″ is used to mount on the center portion of the light guider 20 to cover the black spots of the LED illuminators 30″ during operation. In other words, the figure sign 10″ is used to not only screen the black spots formed by the LED illuminators 30″ but also enhance the visibility of the light guider 20″ when the figure sign 10″ is highlighted. In addition, the figure sign 10″ can be made of translucent material having a light transmisivity or opaque material to cover the black spots of the LED illuminators 30″. The figure sign 10″ can also have a predetermined color to generate multi-colored illumination effect as the neon light effect when the figure sign 10″ is highlighted.

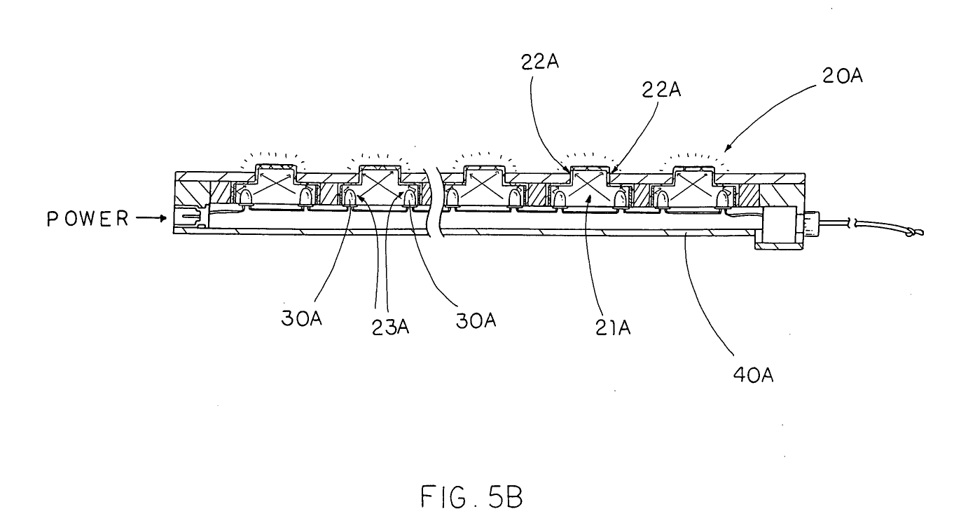

Referring to FIG. 5A of the drawings, a third alternative of the LED sign according to the above preferred embodiment of the present invention is illustrated, in which the light guider 20A has a hollow member which communicates with the light cavity 23A.

Moreover, the two sidewalls 22A of the light guider 20A form two illumination cavities 23A along two sides of the illumination channel 21A respectively wherein the LED illuminators 30A are spacedly disposed in the illumination cavities 23A for generating light towards the illumination channel 21A. Then, the light from the LED illuminators 30A are internally reflected and accumulated within the illumination channel 21A to form a continuous light effect projecting towards the illumination channel 21A in a continuous illuminating manner.

Accordingly, since the LED illuminators 30A are disposed along two sides of the light guider 20A, no black spot is formed along the illumination channel 21A such that the figure sign 10 can be omitted. In other words, when the LED illuminators 30A generate the light towards the illumination channel 21A to form the single line illuminating effect as the neon light effect, the black spots formed by the LED illuminators 30A are hidden within illumination cavities 23A along two sides of the illumination channel 21A′ respectively such that the black spots of the LED illuminators 30A are invisible along the illumination channel 21A.

However, the figure sign 10, as shown in FIG. 1, can be optionally formed on the light guider 20A. Since the figure sign 10 has a predetermined light transmisivity, the continuous light effect forms a single line of light source to highlight the figure sign 10 in a continuous illuminating manner. The figure sign 10 can be made of opaque material, and shaped and sized smaller than that of the light guider 20A, wherein when the LED illuminators 30A are switched off, the figure sign 10 physically forms a display sign in a solid manner, and when the LED illuminators 30A are switched on, the light within the illumination channel 21A forms the continuous illumination effect to encircle a surrounding edge of the figure sign 10 in a shaded font manner.

As shown in FIG. 5B if the drawings, it is worth mentioning that each of the LED illuminators 30A may be embodied as radiating light sidewardly from the head portion of that LED illuminator 30A at an angle of approximately 120° so that although the LED illuminator 30A is facing upwardly in the respective illumination cavity 23A, the light radiating therefrom would propagate sidewardly towards the respective sidewall 22A and the illumination channel 21A.

In order to further enhance internal reflections inside the illumination channel 21A, the light guider 20A further comprises two side reflectors 24A provided on two sidewalls 22A thereof in the light cavities 23A respectively so as to substantially reflect that portion of light impinging on the sidewall 22A back to the illumination channel 21A. As such, the line of light source forming in the illumination channel 21A will be of improved coherence.

The two side reflectors 24A are preferably embodied as two reflective mirrors or silver coatings from which the light can be substantially reflected back to the illumination channel 21A. As shown in FIG. 5B, since the LED illuminators 30A are disposed along two sides of the light guider 20A, no black spot is formed along the illumination channel 21A such that the figure sign 10 can be omitted.

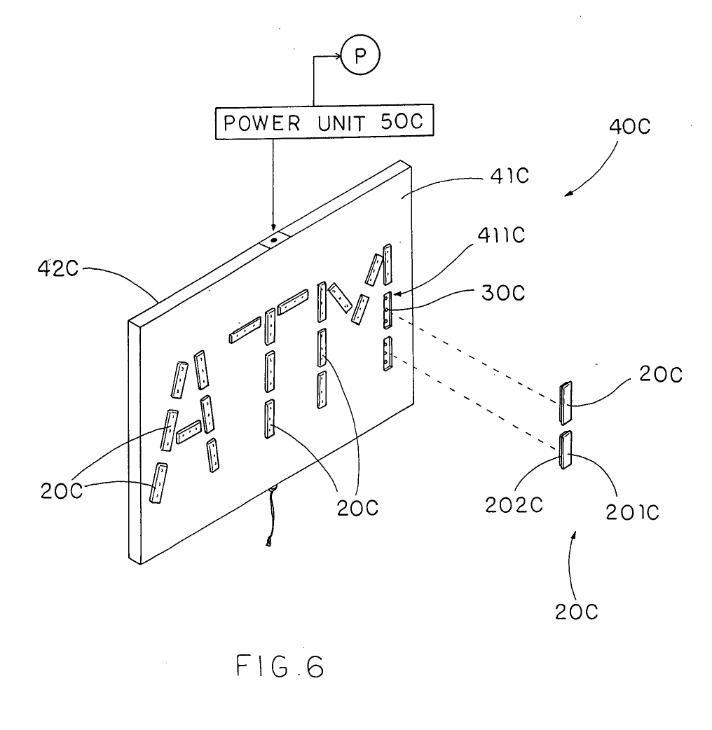

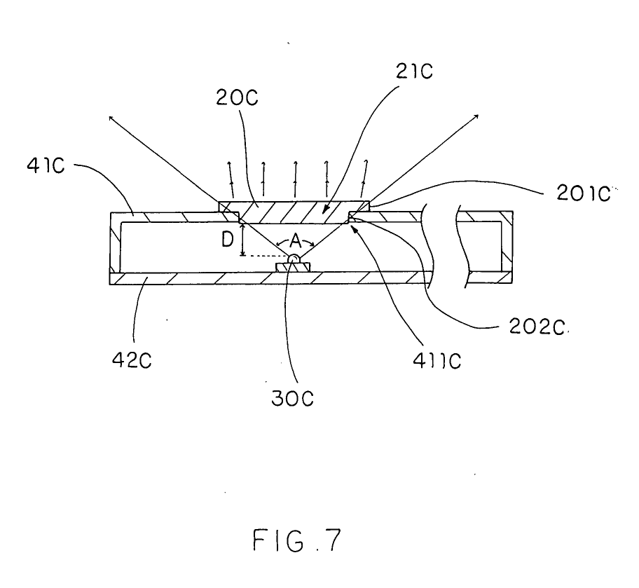

As shown in FIGS. 6 and 7, a LED sign of a second embodiment illustrates an alternative mode of the above first embodiment of the present invention, wherein the LED sign comprises at least a light guider 20C defining an illumination channel 21C therealong and a plurality of LED illuminators 30C spacedly disposed underneath the light guider 20C at a light diffusion distance D for generating lights towards the illumination channel 21C in such a manner that the lights are accumulated within the illumination channel 21C to highlight the light guider 20C so as to form a continuous illumination effect as a neon light effect.

As shown in FIG. 6, the light guider 20C, which is shaped to form a sign word comprises an elongated solid member made of translucent material to form the illumination channel 21C in a solid manner such that when the LED illuminators 30C project the light towards the illumination channel 21C, the light are evenly diffused along the illumination channel 21C to form the continuous illumination effect. In other words, the illumination channel 21C is a physical passageway which has a predetermined light transmisivity so as to allow light passing therethrough.

Each of the LED illuminators 30C is disposed below the light guider 20C at the light diffusion distance D, wherein the LED illuminators 30C are aligned along the light guider 20C at a center portion thereof to substantially project the lights thereto. Each of the LED illuminators 30C forms a point light source to radially generate the light at an illumination angle A towards the light guider 20C wherein the light is diffused at the light diffusion distance D to reach the illumination channel 21C so as to highlight the light guider 20C.

It is worth to mention that when the positions of the LED illuminators 30C are too close to the light guider 20C, i.e. smaller than the light diffusion distance D, a plurality of black spots are formed along the illumination channel 21C. Therefore, the LED illuminators 30C must be positioned at the light diffusion distance D below the light guider 20C to prevent the black spots from being seen along the illumination channel 21C.

Accordingly, the light diffusion distance D can be defined at a distance that each of the LED illuminators 30C projecting the light at the illumination angle A must reach two longitudinal side edge of the light guider 20C, as shown in FIG. 7. In other words, the light projected from the LED illuminator 30C must cover at least the two longitudinal side edge of the light guider 20C so as to ensure the even diffusion of the light along the illumination channel 21C of the light guider 20C. As shown in FIG. 7, the illumination angle A of the LED illuminator 30C is approximately 45° to 60°.

It is worth to mention that the light guider 20C is made of translucent material having a light transmisivity adapted to cover the black spots of the LED illuminators 30C such that when the LED illuminators 30C generate the light within the illumination channel 21C to penetrate through the light guider 20C so as to form the continuous effect when the black spots are invisibly blocked by the light guider 20C. Likewise, the light guider 20C has a predetermined thickness, preferably 5 mm, to enhance the even light diffusion along the illumination channel 21C. Therefore, by incorporating with the light transmisivity of the light guider 20C and the thickness thereof, the light diffusion distance D can be minimized. In other words, the black spots can be invisibly blocked by the light guider 20C and the light diffusion distance D between the light guider 20C and the LED illuminator 30C. In addition, the light guider 20C may have a predetermined color to generate multi-colored illumination effect as the neon light effect when the light guider 20C is highlighted.

As shown in FIGS. 6 and 7, the LED sign further comprises a light housing 40C comprising a sign platform 41C having a guiding slot 411C securely mounting the light guider 20C and a light base 42C supporting the LED illuminators 30C at a position that each of the LED illuminators 30C is spaced apart from the light guider 20C at the light diffusion distance D.

According to the second embodiment, the guiding slot 411C is shaped and sized corresponding to the light guider 20C such that the light guider 20C is substantially mounted on the sign platform 41C at the guiding slot 411C. Accordingly, the light guider 20C has a retention portion 201C having a size larger than a width of the guiding slot 421C and a mounting portion 202C having a size corresponding to the width of the guiding slot 411C, wherein the mounting portion 202C of the light guider 20C fits into the guiding slot 411C until the retention portion 201C of the light guider 20C is rested on the sign platform 41C so as to substantially mount the light guider 20C thereon. In other words, when the light guider 20C is mounted on the sign platform 41C, the retention portion 201C of the light guider 20C is protruded from the sign platform 41C.

As shown in FIGS. 6 and 7, the LED sign further comprises a power unit 50C supported by the light housing 40C to electrically connect with the LED illuminators 30C. Each of the LED illuminators 30C is an individual LED mounted on the light base 42C to align with the light guider 20C at the center portion thereof, i.e. the longitudinal center line of the light guider 20C, wherein the power unit 50C, as a power transformer, is electrically connect the LED illuminators 30C with each other so as to electrically connect to an external power supply P.

It is worth to mention that the LED illuminators 30C are connected in a serial manner such that when the LED illuminators 30C are electrically connected to the external power supply P through the power unit 50C, the LED illuminators 30C generate light towards the light guider 20C.

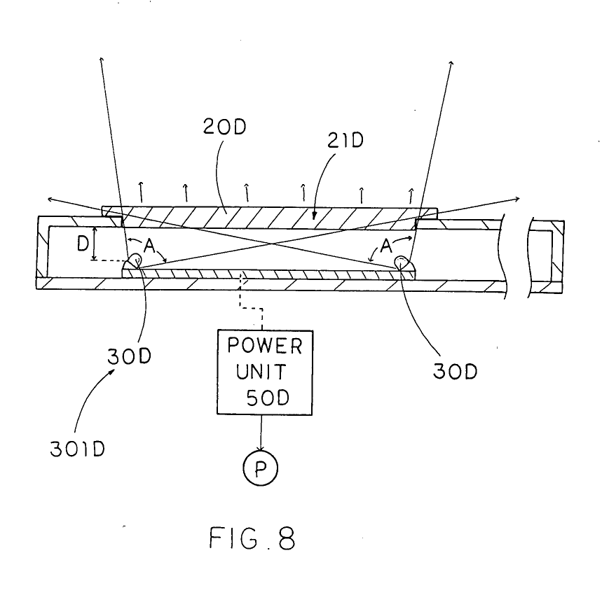

FIG. 8 illustrates an alternative mode of the LED illuminator 30D wherein the LED illuminators 30D are electrically connected with each other to form a LED module 301D. The LED module 301D is shaped and sized corresponding to the light guider 20C and is supported by the light base 42D at a position that the LED module 301D is spaced apart from the light guider 20D at the light diffusion distance D. Therefore, when the LED module 301D is electrically connected to the external power supply P through the power unit 50D, the LED module 301D generate light towards the light guider 20D.

When the LED sign is used as a larger sign board, the size of the light guider 20D must be enlarged such that LED illuminators 30D must be re-arranged their positions to project the light along the illumination channel 21D so as substantially highlight the light guider 20D.

Accordingly, the LED illuminators 30D are formed in pairs wherein the two LED illuminators 30D in pair are positioned below two longitudinal side portions of the light guider 20D respectively to project the lights towards the illumination channel 21D. The two LED illuminators 30D are supported at an inclined manner towards a center portion of the light guider 20D such that the lights from the two LED illuminators 30D can substantially project towards the light guider 20D.

It is worth to mention that three LED illuminators 30D can be aligned to project the lights towards the light guider 20D wherein one of the LED illuminators 30D is positioned below the center portion of the light guider 20D while the rest of the two LED illuminators 30D are positioned below the two longitudinal side portions of the light guider 20D. Therefore, even though the light guider 20D is enlarged, the LED illuminators 30D can substantially project light to highlight the light guider 20D so as to form a continuous illumination effect as a neon light effect.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED sign, comprising:
at least a light guider, which is shaped as a sign word, defining an illumination channel therealong; and
a plurality of LED illuminators spacedly disposed underneath said light guider at a light diffusion distance for generating lights towards said illumination channel in such a manner that said lights are accumulated within said illumination channel to highlight said light guider so as to form a continuous illumination effect as a neon light effect.

2. The LED sign, as recited in claim 1, wherein said light guider, having a predetermined thickness, comprises an elongated solid member made of translucent material to form said illumination channel in a solid manner such that when said LED illuminators project said lights towards said illumination channel, said lights are evenly diffused along said illumination channel to form said continuous illumination effect.

3. The LED sign, as recited in claim 1, wherein said light diffusion distance is defined that each of said LED illuminators projecting said light at an illumination angle reaches two longitudinal side edge of said light guider such that said light from each of said LED illuminators covers at least said two longitudinal side edge of said light guider.

4. The LED sign, as recited in claim 2, wherein said light diffusion distance is defined that each of said LED illuminators projecting said light at an illumination angle reaches two longitudinal side edge of said light guider such that said light from each of said LED illuminators covers at least said two longitudinal side edge of said light guider.

5. The LED sign, as recited in claim 1, further comprising a light housing which comprises a sign platform having a guiding slot securely mounting said light guider therealong and a light base supporting said LED illuminators at a position that each of said LED illuminators is spaced apart from said light guider at said light diffusion distance.

6. The LED sign, as recited in claim 2, further comprising a light housing which comprises a sign platform having a guiding slot securely mounting said light guider therealong and a light base supporting said LED illuminators at a position that each of said LED illuminators is spaced apart from said light guider at said light diffusion distance.

7. The LED sign, as recited in claim 4, further comprising a light housing which comprises a sign platform having a guiding slot securely mounting said light guider therealong and a light base supporting said LED illuminators at a position that each of said LED illuminators is spaced apart from said light guider at said light diffusion distance.

8. The LED sign, as recited in claim 5, wherein said light guider has retention portion having a size larger than a width of said guiding slot and a mounting portion having a size corresponding to said width of said guiding slot, wherein said mounting portion of said light guider fits into said guiding slot until said retention portion of said light guider is rested on said sign platform so as to substantially mount said light guider thereon.

9. The LED sign, as recited in claim 6, wherein said light guider has retention portion having a size larger than a width of said guiding slot and a mounting portion having a size corresponding to said width of said guiding slot, wherein said mounting portion of said light guider fits into said guiding slot until said retention portion of said light guider is rested on said sign platform so as to substantially mount said light guider thereon.

10. The LED sign, as recited in claim 7, wherein said light guider has retention portion having a size larger than a width of said guiding slot and a mounting portion having a size corresponding to said width of said guiding slot, wherein said mounting portion of said light guider fits into said guiding slot until said retention portion of said light guider is rested on said sign platform so as to substantially mount said light guider thereon.

11. The LED sign, as recited in claim 1, wherein each of said LED illuminators is an individual LED aligned with said light guider at a center portion thereof, wherein said LED illuminators are electrically connected with each other to generate said lights towards said illumination channel of said light guider.

12. The LED sign, as recited in claim 7, wherein each of said LED illuminators is an individual LED aligned with said light guider at a center portion thereof, wherein said LED illuminators are electrically connected with each other to generate said lights towards said illumination channel of said light guider.

13. The LED sign, as recited in claim 10, wherein each of said LED illuminators is an individual LED aligned with said light guider at a center portion thereof, wherein said LED illuminators are electrically connected with each other to generate said lights towards said illumination channel of said light guider.

14. The LED sign, as recited in claim 1, wherein said LED illuminators are electrically connected with each other to form a LED module which is shaped and sized corresponding to said light guider such that said LED module generates said lights towards said illumination channel of said light guider.

15. The LED sign, as recited in claim 7, wherein said LED illuminators are electrically connected with each other to form a LED module which is shaped and sized corresponding to said light guider such that said LED module generates said lights towards said illumination channel of said light guider.

16. The LED sign, as recited in claim 10, wherein said LED illuminators are electrically connected with each other to form a LED module which is shaped and sized corresponding to said light guider such that said LED module generates said lights towards said illumination channel of said light guider.

17. The LED sign, as recited in claim 1, wherein said LED illuminators are formed in pairs, wherein said two LED illuminators in pair are positioned below two longitudinal side portions of said light guider respectively to project said lights towards said illumination channel of said light guider.

18. The LED sign, as recited in claim 7, wherein said LED illuminators are formed in pairs, wherein said two LED illuminators in pair are positioned below two longitudinal side portions of said light guider respectively to project said lights towards said illumination channel of said light guider.

19. The LED sign, as recited in claim 10, wherein said LED illuminators are formed in pairs, wherein said two LED illuminators in pair are positioned below two longitudinal side portions of said light guider respectively to project said lights towards said illumination channel of said light guider.

20. The LED sign, as recited in claim 17, wherein said two LED illuminators are supported at an inclined manner towards a center portion of said light guider such that the lights from said two LED illuminators substantially project towards said illumination channel of said light guider.

21. The LED sign, as recited in claim 18, wherein said two LED illuminators are supported at an inclined manner towards a center portion of said light guider such that the lights from said two LED illuminators substantially project towards said illumination channel of said light guider.

22. The LED sign, as recited in claim 19, wherein said two LED illuminators are supported at an inclined manner towards a center portion of said light guider such that the lights from said two LED illuminators substantially project towards said illumination channel of said light guider.
